(19) United States
(12) Patent Application Publication
(10) Pub. No.: US 2007/0024938 A1
(43) Pub. Date: Feb. 1, 2007

(54) Method and apparatus using hologram masks for printing composite patterns onto large substrates

(75) Inventor: Francis Stace Murray Clube, Neuchatel (CH)

Correspondence Address: Holoptics SA, Champs-Montants 12c, Marin, CH-2074, CH

(73) Assignee: Holoptics SA

(21) Appl. No.: 11/188,816

(22) Filed: Jul. 26, 2005

(51) Int. Cl. G03H 1/20

(52) U.S. Cl. 359/12; 359/35

(57) ABSTRACT

A method for printing a composite pattern into a photosensitive layer on a substrate which includes arranging a hologram mask on a first face of a coupling element; arranging the substrate substantially parallel and in proximity to the hologram mask and such that the substrate is laterally positioned with respect to the pattern recorded in the hologram mask; printing the pattern in focus into a part of the photosensitive layer by scanning an exposure beam over the hologram mask and reconstructing the pattern recorded therein while simultaneously measuring the local separation of the substrate and hologram mask where reconstruction is taking place by scanning a focus beam over the hologram mask and continuously correcting the separation by displacing the hologram mask and coupling element; and repeating said arranging and printing steps to print again the pattern into an unexposed part of the photosensitive layer.

The present invention relates to the field of total internal reflection (TIR) holography, and in particular to TIR holography as employed for photolithography.

The prior art teaches that an important application of TIR holography is for printing high-resolution microcircuit patterns, especially on glass substrates for manufacturing certain flat panel displays (e.g. U.S. Pat. Nos. 4,917,497, 4,966,428, 5,640,257, 5,695,894 and 6,657,756). According to the method, a hologram mask is recorded from a conventional chrome mask bearing a pattern of features by firstly placing the mask in close proximity to a holographic recording layer on a glass plate arranged on a glass prism. The mask is then illuminated with an object laser beam whilst simultaneously illuminating the holographic recording layer with a mutually coherent reference laser beam through the prism at such an angle that the reference beam is totally internally reflected from the surface of the holographic layer. The optical interference of the light transmitted by the mask with the reference beam is recorded by the photosensitive material in the holographic recording layer, which is subsequently fixed by an appropriate processing step, to form the hologram mask. The mask pattern can afterwards be regenerated, or reconstructed, from the hologram mask by re-mounting the hologram mask on a glass prism and illuminating it through the prism with a laser beam having the same wavelength as the laser beam used for recording the hologram. The pattern may be printed by placing a substrate, such as a silicon wafer or a glass plate, coated with a layer of photoresist at the same distance from the hologram mask as the chrome mask was during recording.

Because of the close proximity between the holographic layer and mask during recording, and between the hologram and substrate during reconstruction, the TIR holographic method provides a very high numerical aperture (˜1) in comparison with traditional photolithographic methods which enables a relatively high resolution features to be imaged using a given exposure wavelength, for example, 0.4 μm features may be printed with a wavelength of 364 μnm. Further TIR holographic lithography possesses no trade-off between feature resolution and pattern size, so it can print, for example, a 0.4 μm-resolution pattern of dimensions 150 mm×150 mm.

Lithographic exposure equipment based on this technique operating at a UV wavelength of 364 nm has been developed and commercialised. In such a system the hologram mask is mounted to the bottom face of a 45°, 45°, 90° prism with a layer of transparent fluid between the two. The substrate to be printed is mounted to a vacuum chuck and accurately positioned with respect to the hologram by a multi-axis positioning stage. The equipment generally employs a scanning exposure mechanism by which the exposure laser beam is scanned in a raster pattern over the surface of the hologram mask in order that the intensity of the features in the pattern reconstructed from the hologram mask have high uniformity over the pattern area and also so that the pattern can be printed accurately in focus on a substrate whose surface may not be especially flat. This is important because high-resolution images have a limited depth of focus. The focal plane of a hologram mask is offset from the surface of the hologram mask by a distance corresponding to the separation of the recording layer and chrome mask during the recording of the hologram mask. To ensure that the pattern is printed accurately in focus on the substrate, holographic lithographic equipment also integrates a focus system that continuously measures the local separation between the hologram mask and substrate surfaces as the exposure beam scans across the hologram mask, which operates in a feed-back loop with actuators in the substrate positioning system that displace the substrate in response to these measurements in order that the image projected from the hologram mask accurately is uniformly printed in focus onto the substrate surface.

The lithographic equipment further generally integrates an alignment system to allow “higher-level” patterns recorded in hologram masks to be accurately aligned with respect to “lower-level” patterns previously printed onto the substrate surface. This is important for fabricating the complex structure of micro-circuits formed of materials with different electrical properties. The higher-level alignment marks may be recorded into the hologram mask from the chrome mask using just an object-beam exposure of the marks in the mask. The lithographic machine is typically provided with two or more alignment microscopes that image alignment marks in the hologram mask and on the substrate surface onto CCD detectors, and also image processing software that accurately calculates the relative positions of the alignment marks in the hologram mask and on the substrate. In response to these measurements actuators in the substrate positioning system displace the substrate to accurately align it, both translationally and rotationally, with respect to the hologram mask, following which the higher-level pattern is printed onto the lower-level pattern.

Some models of the equipment allow the pattern recorded in the hologram mask to be printed a number of times onto the substrate surface using a “step-and-repeat” exposure sequence, for example, a pattern of dimensions 120 mm×120 mm recorded in the hologram mask may be printed 12 times onto a substrate of dimensions 400 mm×500 mm. In this case the substrate positioning system also integrates large-travel translation.

The equipment may also be provided with automated substrate changing capability so that substrates can be automatically loaded from an input cassette onto the substrate positioning stage for the alignment and exposure sequence and afterwards unloaded and transferred into an output cassette.

The various substrate positioning, exposure, focussing, alignment and substrate changing operations are controlled by a central control unit with a graphical user interface allowing the machine operator to initiate individual machine operations or a completely automatic exposure cycle for substrates in an input cassette.

A drawback with the present lithographic systems based on TIR holography for printing patterns onto large substrates, especially for the manufacture of flat panel displays, is the throughput of the equipment, that is, the speed with which the plates can be printed. The time it takes to print a plate is strongly dependent on the time it takes for the exposure beam to scan back and forth across the hologram mask in typically a raster pattern to print the high-resolution pattern onto the substrate. The speed with which the exposure beam can scan across the hologram mask is mainly limited by the speed of the focus control system, which depends firstly on the speed with which it can measure the local separation of the hologram mask and display substrate where exposure is taking place and secondly on the speed with which substrate positioning system can longitudinally displace the substrate in response to these measurements in order to correct the separation to the value required for the image to be accurately focussed onto the substrate. In the case of large substrates this is particularly difficult because of the size, weight and complexity the substrate positioning system required. Not only does positioning system have to quickly displace the substrate for ensuring accurate focus but it also has to i) arrange that the substrate is supported so that it is accurately flat, which requires a thick and heavy vacuum chuck, ii) laterally displace the substrate by large distances in orthogonal directions so that patterns can be printed from a relatively small hologram mask over the whole area of the substrate, iii) provide high-precision lateral positioning of the substrate with respect to the hologram mask, both translationally and rotationally, in order to provide high-accuracy alignment of a pattern already printed on the substrate with respect to another pattern to be printed from the hologram mask, and also to provide high-accuracy field-to-field stitching to construct a large and essentially continuous composite pattern on the substrate, iv) accurately tilt the substrate about 2 axes so that the part of substrate to be printed with a pattern is accurately parallel with the hologram mask, for the purpose of maximising the resolution and depth-of-focus of the printed patterns, and finally to v) allow the substrate to be loaded onto and off the vacuum by an automatic substrate handling system. These additional requirements mean that the parts of the positioning system that displace with the substrate for achieving focus correction have high mechanical inertia which slows their speed of response to impulsions from actuators, and the other functionalities required of the positioning system also compromise the system's rigidity which can result in significant levels of vibrations, both self-induced and externally excited, which are undesirable both for the focus measurement and the correction.

The throughput of prior-art TIR holographic lithography systems for printing large substrates large is also limited by the necessity to employ and a step-and-repeat procedure with, if necessary, field-to-field stitching in order to print a pattern or patterns over the complete substrate. This is necessary, at least in the case of high-resolution patterns, because of the relatively small size of original chrome mask that are available for recording the hologram masks. Typically the largest dimensions of 0.5 micron-resolution patterns that can be obtained in such masks, which are produced by electron-beam lithographic systems, are 6″×6″ (ie. ˜150 mm×150 mm) which is small compared to the 750 mm×950 mm dimensions of 4^{th}-generation glass substrates employed for display manufacturing, let alone 5^{th}-generation substrates (1100 mm×1250 mm) and beyond. Such a sequential approach for printing over the substrate area means a longer and undesirable printing time per substrate.

It is an object of the present invention to provide a method and apparatus based on total internal reflection holography for printing a pattern over the surface of a substrate whose surface area is much larger than that of a hologram mask such that the time required for printing the pattern is substantially smaller than that possible using such holographic systems according to the prior art.

According to a first aspect of the present invention there is provided a method based on total internal reflection holography for printing a composite pattern into a photosensitive layer on a substrate whose area is substantially larger than that of the pattern recorded in each hologram mask, which method includes:
a) arranging a first hologram mask of a first pattern, having a surface area substantially smaller than that of the substrate, on a first face of a first coupling element;
b) arranging the substrate in relation to the first hologram mask such that it is substantially parallel and in proximity to the first hologram mask and such that it is laterally positioned with respect to at least a first part of the first pattern recorded in the first hologram mask;
c) printing in focus at least the first part of the first pattern recorded in the first hologram mask into the photosensitive layer on the substrate by scanning a first exposure beam through a second face of said first coupling element and reconstructing at least the first part of the pattern recorded in the first hologram mask while simultaneously measuring the local separation of the substrate and first hologram mask where reconstruction is taking place by scanning a first focus beam through the second or a third face of said first coupling element and continuously correcting said separation by displacing the first hologram mask and first coupling element;
d) displacing the substrate in relation to the first hologram mask so that it remains substantially parallel and in proximity to the first hologram mask and such that an unexposed part of the photosensitive layer on the substrate is laterally positioned with respect to the first pattern recorded in the first hologram mask, wherein the lateral positioning of the substrate is substantially or wholly obtained by a lateral displacement of the substrate;
e) printing in focus at least the first or a second part of the first pattern recorded in the first hologram mask into the photosensitive layer on the substrate by scanning a first exposure beam through a second face of said first coupling element and reconstructing at least the first or the second part of the pattern recorded in the first hologram mask while simultaneously measuring the local separation of the substrate and first hologram mask where reconstruction is taking place by scanning a first focus beam through the second or a third face of said first coupling element and continuously correcting said separation by displacing the first hologram mask and first coupling element.

Steps d) and e) of the invention may be repeated a plurality of times, wherein for each arranging step an unexposed part of the photosensitive layer on the substrate is laterally positioned with respect to at least the first, second or another part of the first pattern recorded in the first hologram mask, and for each exposure step at least the first, second or another part of said first pattern recorded in the first hologram is printed into the unexposed part of the photosensitive layer on the substrate, until the complete composite pattern has been printed onto the substrate.

According to the above method, since the hologram mask and coupling element may be a substantially more compact and more rigid body than the substrate and substrate positioning system, the correction of the separation between the hologram mask and substrate during the printing step may be achieved more rapidly, more accurately and without introducing undesirable vibrations, thus enabling a much faster scanning of the exposure and focus beams, and therefore a shorter time for printing the pattern than using the method and equipment according to the prior art.

In the above method the steps of arranging that the substrate is substantially parallel and in proximity with the first hologram mask may be obtained by displacing either the substrate or the first hologram mask and first coupling element, or by a combination of the two.

In the case where the substrate has been previously printed with a lower-level pattern, it is advantageous that each of the steps of the method wherein the substrate is laterally positioned with respect to at least a part of said first pattern recorded in said hologram mask preferably comprises aligning at least a part of the first-level pattern printed on the substrate at least the part of said pattern recorded in the first hologram mask. This alignment may be achieved using techniques described in the prior art, particularly by using microscopes for viewing alignment marks included in the lower-level pattern on the substrate and in the first pattern recorded in the hologram mask measuring, and subsequently displacing at least one of the substrate and first hologram mask to achieve alignment between the to determine the relative lateral positions of the pattern recorded in the hologram mask with respect to the pattern printed on the substrate.

In the case where accurate stitching is required between neighbouring first patterns or parts of the first patterns printed onto the substrate, each step of the method wherein the substrate is laterally positioned with respect to at least a part of the first pattern recorded in the first hologram mask is preferably achieved by displacing the substrate with respect to the axes of a co-ordinate system whose scale and orientation are accurately known with respect to the co-ordinate system of the first pattern recorded in the first hologram mask.

It is further advantageous that the method of the invention further include the additional steps of:
a) arranging a second hologram mask of a second pattern, having a surface area substantially smaller than that of the substrate, on a first face of a second coupling element;
b) arranging the second coupling element and second hologram mask in relation to the first coupling element and first hologram mask such that the second hologram mask is substantially coplanar with the first hologram mask;
c) arranging the substrate in relation to the second hologram mask such that it is substantially parallel and in proximity to the second hologram mask and such that it is laterally positioned with respect to at least a first part of the second pattern recorded in the second hologram mask;
d) printing in focus at least the first part of the second pattern recorded in the second hologram mask into the photosensitive layer on the substrate by scanning a second exposure beam through a second face of said second coupling element and reconstructing at least the first part of the pattern recorded in the second hologram mask while simultaneously measuring the local separation of the substrate and second hologram mask where reconstruction is taking place by scanning a second focus beam through the second or a third face of said second coupling element and continuously correcting said separation by displacing the second hologram mask and second coupling element;
e) displacing the substrate in relation to the second hologram mask such that it remains substantially parallel and in proximity to the second hologram mask and such that an unexposed part of the photosensitive layer on the substrate is laterally positioned with respect to at least the first or a second part of the second pattern recorded in the second hologram mask, wherein the lateral positioning of the substrate is substantially or wholly achieved by a lateral displacement of the substrate; and
f) printing in focus at least the first or second part of the second pattern recorded in the second hologram mask into the photosensitive layer on the substrate by scanning a second exposure beam through a second face of said second coupling element and reconstructing at least the first or second part of the pattern recorded in the second hologram mask while simultaneously measuring the local separation of the substrate and second hologram mask where reconstruction is taking place by scanning a second focus beam through the second or a third face of said second coupling element and continuously correcting said separation by displacing the second hologram mask and second coupling element.

For this case in which the method includes printing from a second hologram mask and a second coupling element it is preferable that for the steps relating to the second hologram mask are performed substantially concurrently with the corresponding steps relating to the first hologram mask. Using such a method in which the first and second patterns are printed concurrently onto a substrate by scanning the first and second exposure beams over said first and second hologram masks, it is clearly possible to print the composite pattern onto the substrate in a time substantially less than for the case where only a single pattern is reconstructed by scanning a single exposure beam over a single hologram mask. Clearly, this principle may be extended to the case of printing concurrently from three or more hologram masks by scanning three or more exposure and focus beams over the respective masks in order to achieve further reductions of the time required to print the composite pattern onto the substrate.

According to a second aspect of the present invention there is provided an apparatus for printing a composite pattern into a photosensitive layer on a substrate, which includes:
a) a first hologram mask of a first pattern, having a surface area substantially smaller than that of the substrate, arranged on a first face of a first coupling element;
b) a substrate positioning means arranged with respect to the first hologram mask on the first coupling element for positioning a substrate arranged thereon substantially parallel to and in proximity to the first hologram mask and for laterally displacing the substrate in at least one of two orthogonal directions relative to the first hologram mask;
c) a first exposure means for reconstructing at least a part of the first pattern recorded in the first hologram mask by scanning a first exposure beam through a second face of the first coupling element;
d) a first focus means for measuring the local separation of the substrate and first hologram mask where at least the part of the first pattern is being reconstructed by said first exposure beam, by scanning a first focus beam through the second or a third face of the first coupling element;
e) a first hologram mask positioning means including means for longitudinally displacing the first coupling element and hologram mask in relation to the substrate in response to said measurements by the first focus means such that the first pattern or part thereof reconstructed from said first hologram mask by said first exposure means is printed in focus into the photosensitive layer on the substrate.

According to the invention the correction of the separation of the first hologram mask and substrate by the displacement of the first hologram mask and first coupling element instead of by the displacement of the substrate by the substrate positioning system according to the prior art allows a much faster correction of the separation because the hologram mask and coupling element can be a much more compact, lighter and more rigid body than the substrate and substrate positioning system. A faster correction of the separation between hologram mask and substrate permits a faster scanning of the exposure beam and therefore larger throughput.

The apparatus of the invention may be enhanced by further including:
a) a second hologram mask of a second pattern, having a surface area substantially smaller than that of the substrate, arranged on a first face of a second coupling element which is arranged in relation to the first coupling element such that the first and second hologram masks are substantially coplanar;
b) a second exposure means for reconstructing at least a part of the second pattern recorded in the second hologram mask by scanning a second exposure beam through a second face of the second coupling element;
c) a second focus means for measuring the local separation of the substrate and second hologram mask where at least a part of the second pattern is being reconstructed by said second exposure beam, by scanning a second focus beam through the second or a third face of the second coupling element;
d) a second hologram mask positioning means including means for longitudinally displacing the second coupling element and second hologram mask in relation to the substrate in response to said measurements by the second focus means such that at least a part of the second pattern reconstructed from the second hologram mask by said second exposure means is printed in focus into the photosensitive layer on the substrate.

In this case it is preferable that the hologram positioning means for the first and second hologram masks include means for laterally displacing each of the respective hologram masks parallel to the surface of the substrate in at least one of two orthogonal directions and preferably also about an axis orthogonal to the plane of the substrate.

Preferred embodiments of the invention will now be described in greater with reference to the following drawings wherein:

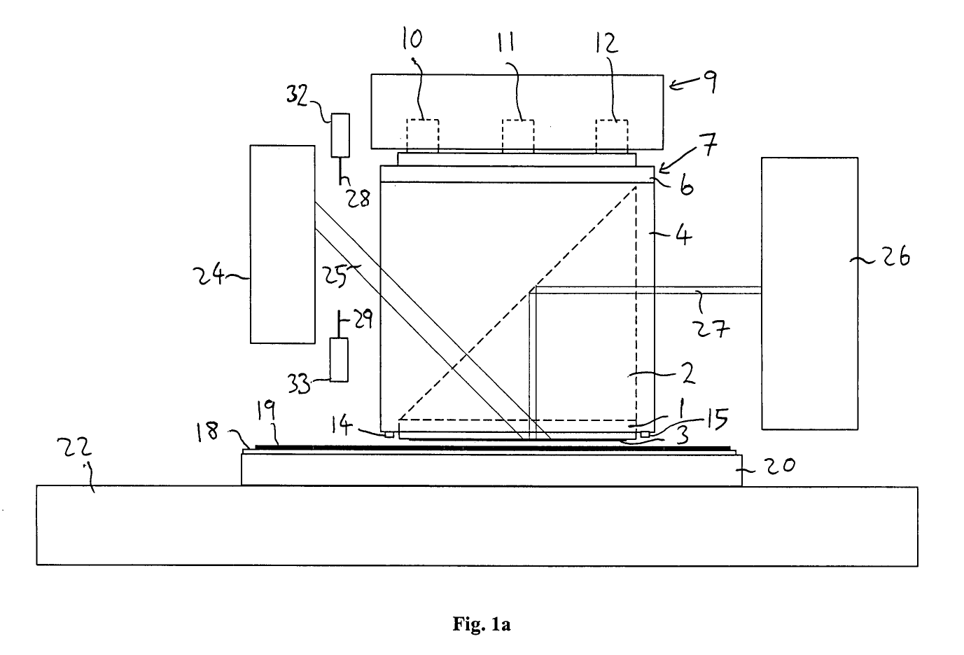

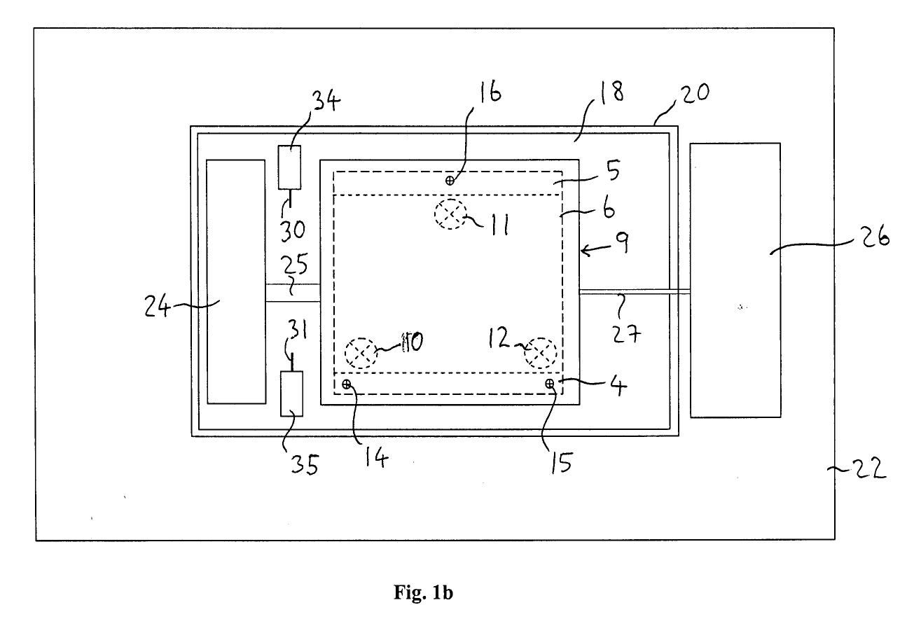

FIGS. 1a and 1b show a side-view and top-view of a first embodiment of the present invention employing a single coupling prism and a single hologram mask.

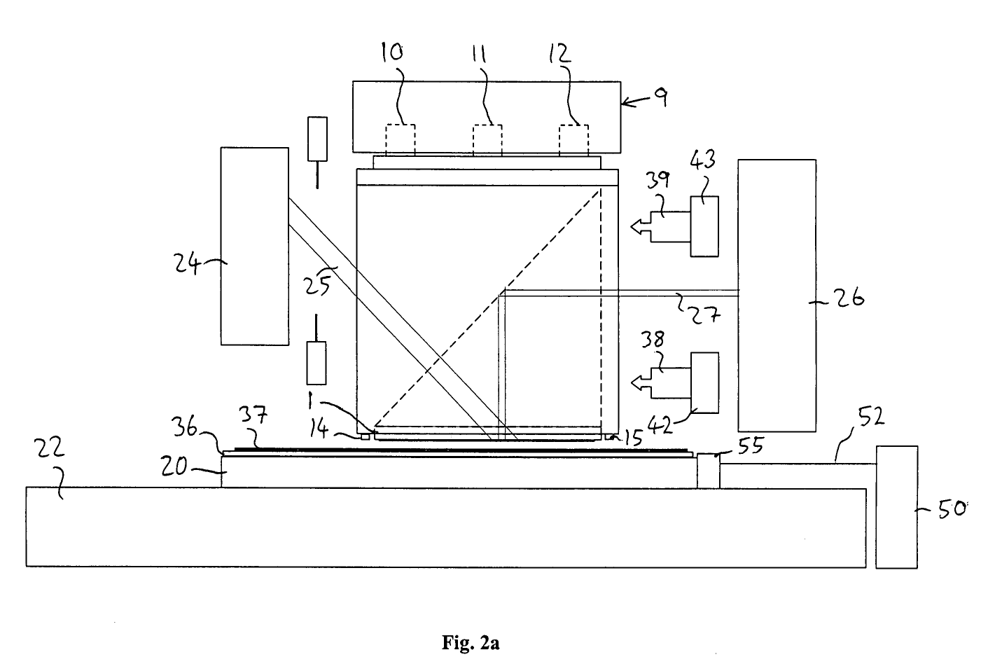

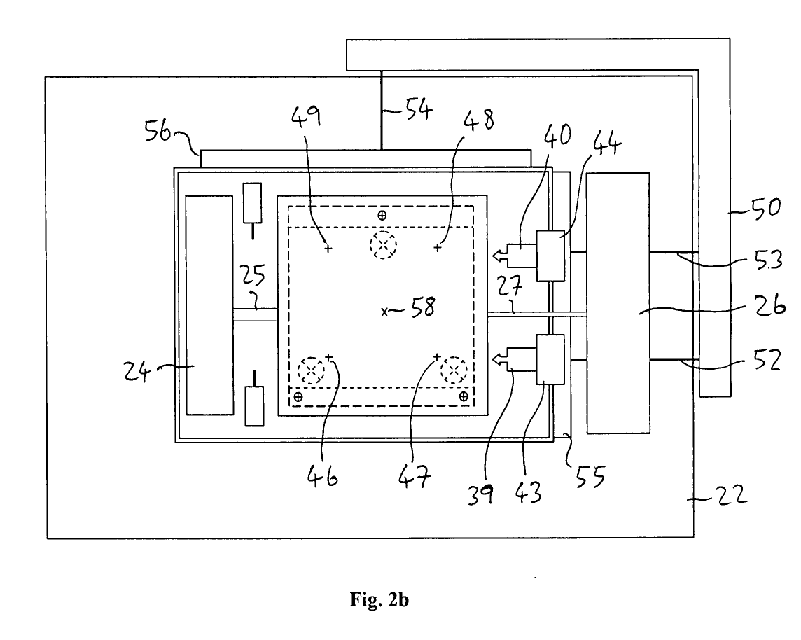

FIGS. 2a and 2b show a side-view and top-view of a second embodiment of the present invention employing a single coupling prism and a single hologram mask.

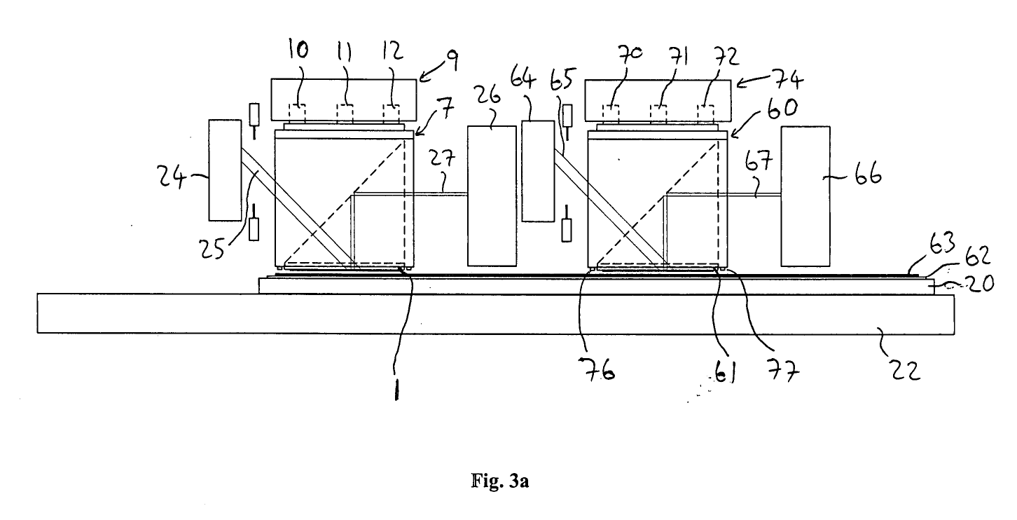

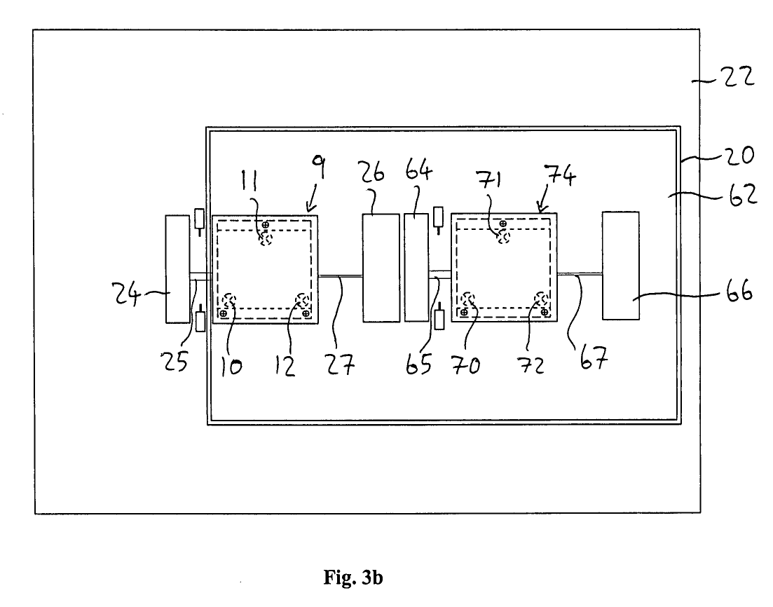

FIGS. 3a and 3b show a side-view and top-view of a third embodiment of the present invention employing two coupling prisms and two hologram masks.

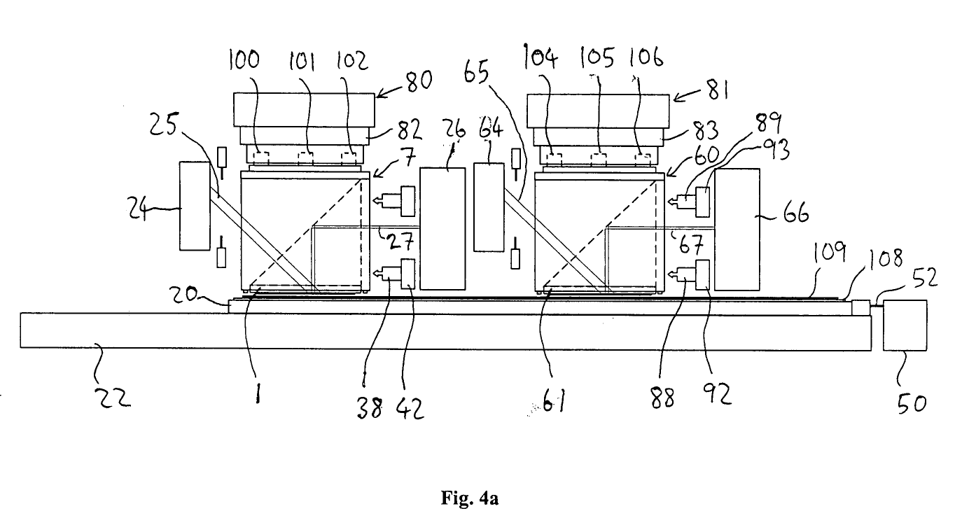

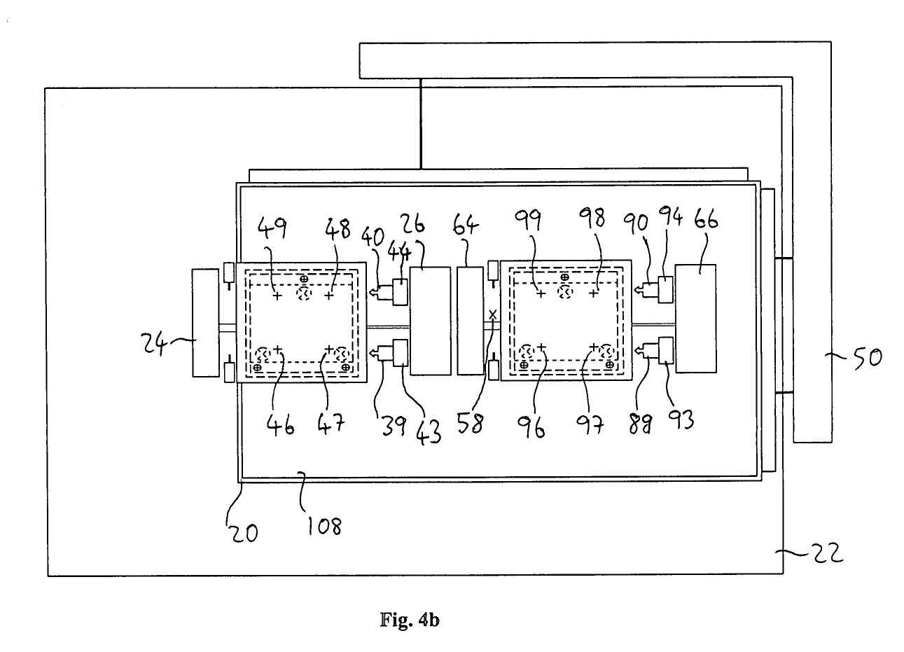

FIGS. 4a and 4b show a side-view and top-view of a fourth embodiment of the present invention employing two coupling prisms and two hologram masks.

FIGS. 1a and 1b show respectively a side-view and a top-view of a lithography system according to the present invention in which a hologram mask 1 of surface area 180 mm×180 mm is arranged on the bottom, square face of a 45°, 45°, 90° glass prism 2 of side length also 180 mm. A layer of transparent fluid has been introduced between the two such that the hologram mask 1 and prism 2 form an optically continuous body, as is required by total internal reflection holography according to the prior art. The hologram is recorded in a polymer layer 3 on the underside of the hologram mask 1. Attached to the triangular faces of the prism are metal side-plates 4, 5 which are connected above to a top plate 6 to form a rigid structure hereafter referred to as the hologram mask and prism assembly 7. The top plate 6 of this assembly 7 is clamped, either manually or automatically using a suitable mechanism, to the platform 8 of a hologram mask positioning system 9 which integrates three high-resolution, vertical-axis actuators 10, 11, 12 preferably integrating piezo-electric transducers (PZTs), which displace the platform 8. The actuators 10, 11, 12 thus enable the height of the hologram mask 1 to be adjusted over some 10s of microns of travel and also enable a fine tilting of the hologram mask 1 about orthogonal horizontal axes. The hologram mask positioning system 9 is only shown schematically in the figure since the many variants for its design would be well known to those skilled in the art of high-precision mechanics. These variants include other forms of interface or attachment to the hologram mask and prism assembly 7 and other system configurations that are arranged either above or around the hologram mask and prism assembly 7, and the include systems having a number of vertical- axis actuators less than or greater than three. It can be advantageous that the vertical displacement of the prism and hologram mask assembly 7 produced by the hologram mask positioning system 9 be additionally constrained by three vertically orientated precision linear guides (not shown in the diagram) preferably arranged close to the plane of the hologram mask 1, in order to ensure that the vertical displacement of the hologram mask 1 produced by the actuators 10, 11, 12 produces minimal or negligible displacement in the horizontal direction or rotation about a vertical axis. Additionally, integrated into the lower surfaces of the prism side-plates is a set of proximity sensors 14, 15, 16 for providing measurements of the separation and parallelism between the hologram mask 1 and a substrate 18 located below the hologram mask 1.

The substrate 18, having dimensions 400 mm×500 mm and ˜1.1 mm thick, is arranged on a vacuum chuck 20 whose upper surface is flat to a few microns. The upper surface of the substrate 18 is coated with a layer of photoresist 19 having a thickness ˜1 μm. The vacuum chuck 20 is mounted to a substrate positioning system 22 consisting of firstly a pair of orthogonally arranged translation stages enabling the substrate 18 to be laterally displaced in a plane substantially parallel to the hologram mask 1. The travel ranges of these two stages allow sufficient displacement of the substrate 18 with respect to the hologram mask 1 in order that a pattern can be printed from the hologram mask 1 over the complete area of the substrate 18 using sequential step-and-expose operations. The substrate positioning system 22 also integrates high-resolution actuators, again preferably piezo-electric transducers, to enable an accurate positioning, both translationally and rotationally, of the substrate 18 in the horizontal plane. Also integrated into the substrate positioning system 22 are three short-travel drives for providing a coarse vertical displacement of the substrate 18 and a tilting of the substrate 18 about orthogonal horizontal axes.

To the left of the hologram mask and prism assembly 7 is an exposure system 24 (shown only schematically here since its composition and configuration are well illustrated and described in the prior art). The exposure system 24 employs a laser source, typically an argon ion laser emitting at a wavelength of 363.8 nm, and beam expansion optics to produce a beam 25 with a Gaussian intensity profile and a cross-section that is small compared to the dimensions of the hologram mask 1. The beam 25 is directed through the hypotenuse face of the prism 2 to the hologram mask 1 at such an angle that it reconstructs the pattern recorded in the hologram mask 1. A 2-axis scanning system in the exposure system 24 allows the beam 25 to be scanned over the complete area of the hologram recorded in the hologram mask 1.

To the right of the hologram mask and prism assembly 7 is a focus system 26, again only shown schematically since its composition and operation are also well described in the prior art. The output beam 27 from the focus system 26 passes through the vertical face of the prism 2, is totally internally reflected from its hypotenuse face and illuminates the hologram mask 1 and substrate 18 at normal incidence. The beam 27 is also is aligned with the exposure beam 25 at the polymer layer 3 on the hologram mask 1 so that it continuously measures the exact separation of the hologram mask 1 and substrate 18 where the pattern is being locally reconstructed by the scanning exposure beam. The mutually coherent reflections of the focus beam 27 from the surfaces of the hologram mask 1 and substrate 18 interfere and return to the focus system 26 where the light is spectrally dispersed onto a linear CCD detector and the oscillations in the resulting spectrum are analysed by the control system to yield a measurement of the local separation between the hologram mask 1 and substrate 18. The focus system 26 also employs a 2-axis scanning system to displace the focus beam 27 over the complete area of the hologram recorded in the hologram mask 1.

The substrate 18 is printed by firstly displacing the substrate positioning system 22 such that a corner of the substrate 18 is below the area of the hologram mask 1 in which the pattern is recorded. Following this the three vertical-axis motors in the substrate positioning system 22 displace until the proximity sensors 14, 15, 16 arranged in the lower surface of the prism side-plates 4, 5 detect that the part of the substrate 18 to be printed is substantially parallel to the hologram mask 1 and approximately separated from it by a value corresponding to the focal distance of the hologram mask 1. Following this the pattern recorded in the hologram mask 1 is reconstructed by scanning the exposure beam 25 in a raster pattern over the hologram mask 1. The stepping distance between successive passes of the scanning beam is selected in relation to the diameter of the 1/e² diameter of the Gaussian beam, as is taught in the prior art, such that the time-integrated exposure energy density illuminating the hologram mask 1 is highly uniform. As the exposure beam 25 scans across the hologram mask 1, the focus beam 27 scans synchronously with it measuring the local separation of the hologram mask 1 and substrate 18 at the centre of the exposure beam 25. In response to these measurements, the three vertical-axis actuators 10, 11, 12 in the hologram mask positioning system 9 displace in order to correct the measured separation to the value corresponding to the focal distance of the hologram mask 1. FIGS. 1a and 1b, and indeed all the figures illustrating the particular embodiments of the invention, do not explicitly show the control system governing the motions of the various displaceable parts and their interactions with the various sensors and measurement systems, for example the continuous closed-loop interaction during the printing operation between the measurements of the focus system 26 and the displacements of the actuators 10, 11, 12 for correcting the separation of the hologram mask 1 and substrate 18 where the exposure beam 25 is reconstructing the pattern in the hologram mask 1. The general structure and operation of the control systems for the various embodiments, comprising both hardware and software aspects as well as suitable graphical and other interfaces for user-friendly operation, would be well-known to those skilled in the art of such control systems.

Once the exposure scanning sequence has been completed, the substrate positioning system 22 displaces to present an unexposed part of the photosensitive layer 19 to the hologram mask 1. As before, the part of the substrate 18 to be exposed is levelled with the hologram mask 1 and positioned at a distance corresponding to the focal plane of the hologram mask 1. Following this, the exposure and focus sequence is re-run to print again the pattern recorded in the hologram mask 1 into the photoresist layer 19 on the substrate 18. This sequence of operations is repeated many times until all or a substantial part of the substrate 18 has been printed. The exposed substrate 18 is then taken off the chuck 20 and developed using standard resist processing techniques.

A variation of the procedure may be employed when the pattern recorded in the hologram mask 1 comprises an arrangement of sub-patterns. In this case the exposure and focus systems 24, 26 may be instructed to scan over just one or more of the sub-patterns recorded in the hologram mask 1 such that just a part of the total pattern recorded in the hologram mask 1 is printed onto the substrate 18. Clearly, with this procedure the particular sub-pattern or sub-patterns exposed in each exposure step may furthermore be different from one step to the next. With this printing strategy, it is advantageous that the embodiment include four mechanical blades 28, 29, 30, 31 mounted on individual translation stages 32, 33, 34, 35 located between the exposure system 24 and the hypotenuse face of the prism 2. The stages 32, 33, 34, 35 then position the blades 28, 29, 30, 31 before the exposure operation in order to shield from the scanning exposure beam 25 those sub-patterns neighbouring the sub-pattern to be reconstructed to ensure that they are not also partially printed. With such a shielding mechanism the separations between the sub-patterns recorded in the hologram mask 1 may be minimised in order to maximise the total pattern area in the mask.

FIGS. 2a and 2b show a side-view and top-view of a second embodiment of the invention which additionally employs an alignment system to enable a “higher-level” pattern recorded in the hologram masks 1 to be accurately aligned with respect to a “lower-level” pattern previously printed (using also post-exposure processes such as resist development and etching) on a substrate 36 below a layer of photoresist 37. In this embodiment, four alignment microscopes 38, 39, 40, 41 are arranged alongside the hologram mask and prism assembly 7 for measuring the positions of reference alignment marks 46, 47, 48, 49 included at the four corners of an upper-level pattern recorded in the hologram mask 1 with respect to corresponding alignment marks (not illustrated in the diagram) included at the four corners of a lower-level pattern previously formed on the substrate 36. Each of the microscopes 38, 39, 40, 41 is mounted to separate translation stages 42, 43, 44, 45 enabling the alignment marks 46, 47, 48, 49 to be located over a large area of the hologram mask 1, and each of the microscopes 42, 43, 44, 45 contains a CCD camera linked to an image processing capability in the control system to allow an automatic and rapid measurement of the relative positions of the upper-level alignment marks 46, 47, 48, 49 with the respective lower-level alignment marks on the substrate 36. The exact composition and operation of the alignment microscopes 38, 39, 40, 41 and alignment systems in general as employed on lithographic equipment based on TIR holography are adequately described in the prior art, so are not reproduced here.

Thus, using this embodiment, following the measurements by the microscopes 38, 39, 40, 41 of the relative positions of the patterns recorded in the hologram mask 1 with respect to the patterns present on the substrate 36, the actuators in the substrate positioning system 22 displace to accurately align the lower-level pattern on the substrate 36 with respect to the upper-level pattern in the hologram mask 1. The accuracy of this operation may be subsequently validated by using the microscopes 38, 39, 40, 41 to re-measure the relative positions of the alignment marks 46, 47, 48, 49 in the hologram mask 1 with respect to those on the substrate 36, after which a further correction may be performed. Once aligned, the upper-level pattern is printed from the hologram mask 1 into the layer of photoresist 37 on the substrate 36.

This embodiment also includes a 3-axis interferometer system 50 configured around the substrate positioning system 22 to enable a high-accuracy measurement of the displacement of the substrate 36 on the vacuum chuck. Two measurement beams 52, 53 of this system are retro-reflected by a first long mirror 55 mounted alongside the chuck 20 on the substrate positioning system 22 and a third measurement beam 54 is reflected by a second long mirror 56 mounted orthogonally alongside the chuck 20. The details and operation of this interferometer position measurement system 50, such as are manufactured by the companies Zygo Inc. and Hewlett-Packard, are well known to those skilled in the art so are only shown schematically in the diagram are not described here.

The interferometer system 50 enables “same-level” patterns that are sequentially printed from the hologram mask 1 (ie. without an intermediate development and post-exposure processing steps) to be mutually aligned, or stitched, with high accuracy. With such a stitching capability it is possible to compose very large and essentially continuous patterns on the substrate 36, which is important for, for example, manufacturing large-format flat panel displays.

To obtain accurate stitching between patterns sequentially printed from the hologram mask 1 onto a substrate, it is first necessary to determine the orientation and dimensions of the pattern recorded in the hologram mask 1 with respect to the interferometer system 50. This may be achieved using a single reference mark 58 included at or near the centre of the upper surface of the vacuum chuck 20 (alternatively such a reference mark could be on the surface of a reference substrate arranged on the vacuum chuck 20). Briefly, the procedure comprises firstly using the substrate positioning stage 22, without the substrate 36 loaded onto it, to arrange that the reference mark 58 on the chuck 20 is below a first alignment mark 46 recorded in the hologram mask 1 and so that the surface of the vacuum chuck 20 is substantially parallel to the hologram mask 1 and separated from it by a distance corresponding approximately to the focal distance of the hologram mask 1. Next the respective alignment microscope 38 is displaced using its translation stages 42 to view the two marks 58, 46 and to measure their relative positions. Following this the substrate positioning stage 22 is displaced again to accurately align the reference mark 58 on the vacuum chuck 20 with the alignment mark 46 in the hologram mask 1. The position of the reference mark 58 on the vacuum chuck 20 at alignment, as measured by the interferometer system 50, is stored. The vacuum chuck is then displaced to successively align the reference mark 58 with each of the other three alignment marks 47, 48, 49 in the hologram mask 2 using the respective microscopes 39, 40, 41 and storing the measurement values of the interferometer system 50 after each alignment. From the stored sets of co-ordinate data can be calculated the orientation, position and dimensions of the pattern recorded in the hologram mask 1 with respect to the interferometer system 50. Following this, the vacuum chuck 20 is displaced away from the hologram mask 1 and the substrate 36 coated with a layer of photoresist 37 is re-loaded onto it. The substrate positioning system 22 is then displaced so that the substrate 36 is at the first exposure position, so that it is substantially parallel to the hologram mask 1 and separated from it by a distance approximately corresponding the focal distance of the hologram mask 1. A fine adjustment of the levelling and separation of the two hologram mask 1 with respect the substrate 36 may be performed using the vertical axis actuators 10, 11, 12 in the hologram mask positioning system 9. The scanning exposure sequence can then proceed using the exposure and focus systems 24, 26 and the vertical-axis actuators 10, 11, 12 in the hologram mask positioning system 9 to ensure that the pattern is accurately printed in focus onto the substrate 36. Advantageously, as previously mentioned, rather than printing the complete pattern recorded in the hologram mask 1, the scanning sequence may print just a part of the respective pattern. After exposure, the substrate 36 is accurately displaced according to the measured dimensions and orientations of the pattern or a sub-pattern recorded in the hologram mask 1 in order to print again the pattern, or a part thereof, onto an unexposed area of the substrate 36.

In order to achieve greater overlay accuracy between upper-level and lower-level patterns and also greater stitching accuracy between same-level patterns it is preferable that 3 high-resolution proximity sensors (not shown in the diagram) are mounted to the lithography system around the hologram mask and prism assembly 7 and close to the plane of the hologram mask 1 in order to accurately determine any lateral motion, translational and rotational, of the hologram mask 1 produced by the vertical displacement of the hologram mask 1 required during the printing operation to ensure that the pattern is accurately printed in focus onto the substrate 36. Examples of such sensor elements are capacitive sensors. By continuously measuring the lateral position of the hologram mask 1 during the scanning exposure sequence, any lateral displacements of the hologram mask 1 may be continuously compensated by equivalent displacements of the substrate using the horizontal-axis actuators in the substrate positioning stage 22. Such a mechanism can also enhance the printing resolution of the equipment (thus may also be applied to the first embodiment of the invention).

FIGS. 3a and 3b show a side-view and a top-view of a third preferred embodiment of the invention which employs two prism and hologram mask assemblies 7, 60 of the type as described and illustrated in the first embodiment. Each of the hologram mask and prism assemblies 7, 60 has its own independent exposure system 24, 64 and independent focus system 26, 66. The patterns recorded in the two hologram masks 1, 61 may be same or different. The separation between the centres of the hologram masks 1, 61 should correspond approximately to half the length of the substrate 62 to be printed on the equipment such that the first prism and hologram mask assembly 7 is employed for printing onto one half of the substrate 62 and the other prism and hologram mask assembly 60 is employed for printing onto the other half. In order to maximise the number of patterns that may be printed onto the substrate 62, the relative positions of the patterns should be optimally arranged in the hologram masks 1, 61.

Using this embodiment, the substrate 62 is first laterally displaced using the substrate positioning system 22 to the first exposure position and then raised using the vertical-axis motors therein such the substrate 62 is approximately parallel to each of the hologram masks 1, 61 and separated from each of them by an amount approximately corresponding to the focal distance of the hologram masks 1, 61. Following this, the vertical-axis actuators 10, 11, 12 in the positioning system 9 for the first hologram mask and prism assembly 7 displace until the proximity sensors 14, 15, 16 arranged in the lower surfaces of the prism side-plates 4, 5 detect that the hologram mask 1 is parallel to the surface of the substrate 6 and separated therefrom by an amount corresponding to the focal distance of the hologram mask 1. This operation is repeated for the second hologram mask 61 using the vertical-axis actuators 70, 71, 72 integrated in the positioning system 74 for the second hologram mask and prism assembly 60 and using the corresponding proximity sensors 76, 77, 78 to detect the separation and parallelism between the hologram mask 61 and substrate 62. Following this, the substrate 62 is printed by scanning the hologram masks 1, 61, preferably simultaneously, with exposure beams 25, 65 from the respective exposure systems 24, 64 whilst scanning the focus beams 25, 65 to continuously measure the separations of the hologram masks 1, 61 and substrate 62 where the patterns are being locally reconstructed and using the using the vertical-axis actuators 10, 11, 12 and 70, 71, 72 in the respective hologram mask positioning systems 9, 74 according to the measurements of the respective focus systems 26, 66 in order that the patterns are accurately printed in focus on the substrate 62 from the hologram masks 1, 61. The substrate 62 is then displaced to a second exposure position and the levelling, gap setting, exposure and focus sequence is repeated, and so on, until the patterns recorded in the hologram masks 1, 61 have been printed over a large area of the substrate 62.

With this particular embodiment and procedure the patterns printed onto the substrate from the separate exposures will in the general case not be accurately aligned, or stitched, with respect to each other, so are suitable for a manufacturing process in which the devices derived from the individual exposures are discrete components.

FIGS. 4a and 4b show a side-view and a top-view of a further embodiment of the invention also employing two hologram mask and prism assemblies 7, 60 that additionally allows “higher-level” patterns recorded in the hologram masks 1, 61 to be accurately aligned with respect to “lower-level” patterns already formed on the substrate 108 by a previous printing and post-exposure processes (such as development of the photoresist and then an etching) before printing the upper-level patterns into a layer of photoresist 109 coated over the lower-level patterns on the substrate 108. In this embodiment, each of the hologram mask positioning systems 80, 81 integrate not only vertical-axis actuators 101, 101, 102 and 104, 105, 106 for providing vertical displacement and a fine tilting of the holograms masks 1, 61 about orthogonal horizontal axes but also lateral positioning stages 82, 83 incorporating horizontal-axis actuators 100, 101, 102 and 104, 105, 106 for laterally displacing the hologram masks 1, 61 with respect to each other in the horizontal plane. These actuators 100, 101, 102 and 104, 105, 106 enable translational displacements of each of the hologram masks 1, 61 in orthogonal directions with, for example, a travel range of 10 mm and a resolution of movement of 50 nm, and also a small rotation of each of the hologram masks 1, 61 about a vertical axis with a correspondingly high angular resolution. As for the earlier embodiments, each of the hologram mask and prism assemblies 7, 60 has proximity sensors 14, 15, 16 and 76, 77, 78 respectively for measuring the separations of the hologram masks 1, 61 from the substrate 108 on the chuck 20.

In this embodiment, like for the second embodiment, four alignment microscopes 38, 39, 40, 41 are arranged alongside the first hologram mask and prism assembly 7 for measuring the positions of reference alignment marks 46, 47, 48, 49 included at the four corners of an upper-level pattern recorded in the hologram mask 1 with respect to corresponding alignment marks included at the four corners of a lower-level pattern previously formed on the substrate 108. Each of the microscopes 38, 39, 40, 41 is mounted to a translation stage 42, 43, 44, 45 enabling the microscope to view alignment marks located over a large area of the hologram mask 1, and each microscope contains a CCD camera linked to an image processing capability in the control system to allow an automatic and rapid measurement of the relative positions of the respective marks. A second set of four microscopes 88, 89, 90, 91 on translation stages 92, 93, 94, 95 is similarly provided alongside the second hologram mask and prism assembly 60 for measuring the positions of equivalent alignment marks 96, 97, 98, 99 at the corners of the upper-level pattern recorded in the second hologram mask 61 with respect to corresponding alignment marks at the corners of a lower-level pattern present on the substrate 108. Thus, using this embodiment, following the adjustment of the separation and parallelism between each of the hologram masks 1, 61 and the substrate 108, using the substrate and hologram masks positioning systems 22, 80, 81, the substrate positioning stage 22 and hologram mask positioning stages 80, 81 then displace respectively the substrate 62 and hologram mask assemblies 7, 60 such that alignment marks 46, 47, 48, 49 in the first hologram mask 1 and the alignment marks 96, 97, 98, 99 in the second hologram mask 61 are all approximately aligned with the corresponding lower-level alignment marks previously printed on the substrate 108 below the layer of photoresist 109. Next, the microscope positioning stages 42, 43, 44, 45 for the first hologram mask and prism assembly 7 displace the respective microscopes 38, 39, 40, 41 so that the microscopes are able to image and measure the relative positions of the alignment marks 46, 47, 48, 49 in the hologram mask 1 and the corresponding marks on the substrate 108. Similarly the microscope positioning stages 92, 93, 94, 95 for the second hologram mask and prism assembly 60 displace the respective microscopes 88, 89, 90, 91 so that the microscopes are able to image and measure the relative positions of the alignment marks 96, 97, 98, 99 in the hologram mask 2 and the corresponding marks on the substrate 108. Following the measurements by the microscopes 38, 39, 40, 41 and 88, 89, 90, 91 of the relative positions of the patterns recorded in the hologram masks 1, 61 with respect to the patterns present on the substrate 62, the actuators in the hologram mask positioning systems 80, 81 laterally displace the respective hologram masks 1, 61 in order to accurately align the patterns recorded therein with respect to those present on the substrate 108 (the substrate positioning stage 22 may also be employed to perform this operation). The accuracy of this resulting alignment may be subsequently validated by re-measuring the relative positions of the alignment marks in the hologram masks 1, 61 with respect to those on the substrate 108 and, if necessary, performing a further correction. Once aligned, the upper-level patterns are printed from the hologram masks 1, 61 into the layer of photoresist 109 coated on the substrate 108 by scanning, preferably simultaneously, the exposure and focus beams 25, 65, 27, 67 from the respective exposure and focus systems 24, 64, 26, 66 over the hologram masks 1, 61. For this operation, it is necessary that the control system that determines the scanning paths of each of the exposure and focus beams 25, 65, 27, 67 takes account of the prior lateral displacements of the hologram mask and prism assemblies 7, 60, in order that the focus beams 27, 67 are accurately aligned with the exposure beams 25, 65 at the surfaces of the hologram masks 1, 61 during the scanning sequence.

In addition to enabling high-accuracy overlay between higher-level patterns printed from the hologram masks 1, 61 with respect to lower-level patterns previously fabricated on a substrate 108, this embodiment also enables “same-level” patterns that are sequentially or simultaneously printed from the hologram masks 1, 61 (ie. without an intermediate development or post-exposure processing) to be mutually aligned, or stitched, to produce a much larger composite pattern on a substrate. This is achieved using a similar procedure to that described above in the second embodiment of the invention: the substrate positioning stage 22, without a substrate on the vacuum chuck 20, is displaced so that the surface of the vacuum chuck 20 is substantially parallel to each of the hologram masks 1, 61 and is approximately separated from them by a distance corresponding to the focal distance of the hologram masks 1, 61. The vertical-axis actuators 101, 101, 102 in the hologram mask positioning systems 80, 81 then displace to provide a more accurate parallelism and separation between the hologram masks 1, 61 and the surface of the vacuum chuck 20. Next, the substrate positioning stage 22 displaces the chuck 20 so that the reference mark 58 on its surface is below one of the alignment marks 46 recorded in the first hologram mask 1, and the respective alignment microscope 38 is displaced by its stage system 42 to view the two marks 58, 46 and to measure their relative positions. The position of the reference mark 58 on the vacuum chuck 20 at alignment, as measured by the interferometer system 50, is stored. This procedure is repeated to successively align the reference mark 58 on the vacuum chuck 20 firstly with each of the other three alignment marks 47, 48, 49 in the first hologram mask 1 and secondly with each of the four alignment marks 96, 97, 98, 99 in the second hologram mask 61, storing the measurement values of the interferometer system 50 after each alignment. From the stored sets of co-ordinate data are calculated the relative positions, orientations and dimensions of the patterns recorded in the two hologram masks 1, 61 with respect to the interferometer system 50. Based on this information the relative lateral positions of the first and second hologram masks 1, 61 are adjusted using the lateral positioning stage systems 82, 83 within the respective hologram mask positioning systems 80, 81 in order that the patterns recorded in the hologram masks 1, 61 are accurately located, translationally and rotationally, with respect to each other. Preferably, the procedure for determining the relative positions of the two hologram masks 1, 61, as outlined above, is then repeated to validate their new positions and, if necessary to permit a more accurate correction. Following this, the vacuum chuck 20 is displaced away from the hologram masks 1, 61 and a substrate 108 coated with a layer of photoresist 109 is loaded onto it. The substrate positioning system 22 is then displaced so that the substrate 108 is at the first exposure position, so that it is substantially parallel to the hologram masks 1, 61 and separated from it by a distance approximately corresponding to the focal distance of the hologram masks 1, 61. A fine adjustment of the levelling and separation of the two hologram masks 1, 61 with respect the substrate 62 may be performed using the vertical axis actuators 101, 101, 102 and 104, 105, 106 in the respective hologram mask positioning systems 80, 81. The scanning exposure sequence then proceeds, again preferably simultaneously for the two hologram masks 2, 100, using the two exposure systems 58, 96 and the vertical-axis actuators 101, 101, 102 and 104, 105, 106 in the respective hologram mask positioning systems 80, 81 to ensure that the patterns are accurately printed in focus into the photoresist layer 109 on the substrate 108. As for printing after an alignment of lower-level patterns on the substrate 108 with respect to higher-level patterns in the hologram masks 1, 61, it is necessary that the control system governing the motion of the exposure and focus beams 25, 65, 27, 67 takes account of the positions of the hologram mask and prism assemblies 7, 60, so that the focus beams 27, 67 are accurately aligned with the respective exposure beams 25, 65 at the surfaces of the hologram masks 1, 61 during the scanning sequence. Further, as previously mentioned, rather than printing the complete patterns recorded in the hologram masks 2, 100, the scanning sequence may alternatively print just parts of the respective patterns. After exposure, the substrate 108 is accurately displaced according to the measured positions, dimensions and orientations of the patterns recorded in the hologram masks 2, 100 and, if necessary, adjusting the lateral positions of the hologram masks 2, 100 using the hologram mask lateral positioning systems 82, 83 before printing again the patterns from the hologram masks 2, 100, or parts thereof, onto unexposed areas of the substrate 108. This sequence is repeated as many time as necessary to print the desired total pattern on the substrate 108.

Using this embodiment, in which the hologram masks are accurately positioned with respect to each other, the patterns printed onto the substrate may be accurately stitched together to form a very large and essentially continuous pattern. This capability is important for manufacturing large-format flat panel displays.

In another embodiment of this invention employing two hologram mask and prism assemblies, additional interferometer systems are integrated onto the equipment to provide accurate measurements of the lateral positions of the respective hologram masks, in order to achieve higher stitching accuracy between patterns printed onto the substrate.

Whereas the embodiments described in FIGS. 3 and 4 above show the two hologram mask and prism assemblies 7, 60 to have the same orientation, in other embodiments the second assembly 60 and its associated exposure and focus systems 24, 64 and 26, 66 may be rotated by 180° about a vertical axis such that the two exposure systems 24, 64 are at the left and right edges of the arrangement and the two focus systems 26, 66 are in the middle (or alternatively vice versa). Also, rather than the two hologram mask and prism assemblies 7, 60 being separated longitudinally, that is with the triangular faces of the two prisms being substantially coplanar, the two hologram mask and prism assemblies 7, 60 (and their respective positioning, exposure and focus systems) may be separated in the orthogonal direction in the horizontal plane, so that the vertical faces of the two prisms are substantially coplanar.

Clearly, other embodiments of the invention may include three or more hologram mask and prism assemblies, each with their own independent exposure, focus and other sub-systems, for the purpose of further reducing the total time required for printing a pattern over the whole or a substantial part of the substrate surface.

1. A method for printing a composite pattern into a photosensitive layer on a substrate, which method includes:
a) arranging a first hologram mask of a first pattern, having a surface area substantially smaller than that of the substrate, on a first face of a first coupling element;
b) arranging the substrate in relation to the first hologram mask such that it is substantially parallel and in proximity to the first hologram mask and such that it is laterally positioned with respect to at least a first part of the first pattern recorded in the first hologram mask;
c) printing in focus at least the first part of the first pattern recorded in the first hologram mask into the photosensitive layer on the substrate by scanning a first exposure beam through a second face of said first coupling element and reconstructing at least the first part of the pattern recorded in the first hologram mask while simultaneously measuring the local separation of the substrate and first hologram mask where reconstruction is taking place by scanning a first focus beam through the second or a third face of said first coupling element and continuously correcting said separation by displacing the first hologram mask and first coupling element;
d) displacing the substrate in relation to the first hologram mask so that it remains substantially parallel and in proximity to the first hologram mask and such that an unexposed part of the photosensitive layer on the substrate is laterally positioned with respect to the first pattern recorded in the first hologram mask;
e) printing in focus at least the first or a second part of the first pattern recorded in the first hologram mask into the photosensitive layer on the substrate by scanning a first exposure beam through a second face of said first coupling element and reconstructing at least the first or the second part of the pattern recorded in the first hologram mask while simultaneously measuring the local separation of the substrate and first hologram mask where reconstruction is taking place by scanning a first focus beam through the second or a third face of said first coupling element and continuously correcting said separation by displacing the first hologram mask and first coupling element.

2. A method according to claim 1 wherein the arranging and printing steps are repeated a plurality of times to print the first, second or other parts of the pattern recorded in the hologram mask into a plurality of unexposed parts of the photosensitive layer on the substrate.

3. A method according to claim 1 wherein the lateral positioning, in steps b) and d), of the substrate with respect to at least a part of the first pattern recorded in the first hologram mask is wholly or substantially obtained by displacing the substrate and otherwise by displacing the first hologram mask and first coupling element.

4. A method according to claims 1, which includes the additional step of accurately measuring at least one of the orientation and dimensions of the first pattern or part thereof recorded in the first hologram mask, and wherein the displacement of the substrate between at least two of successive printing steps is such that the resulting first patterns or parts thereof printed on the substrate are accurately aligned, or stitched together.

5. A method according to claim 1, which includes before at least one of the printing steps the additional steps measuring the lateral positions of the first pattern or part thereof recorded in the first hologram mask relative to a pattern or part thereof previously printed below the photosensitive layer on the substrate, and secondly displacing the substrate such that pattern or part thereof printed from the first hologram mask is accurately aligned with respect to the pattern or part thereof printed on the substrate below the photosensitive layer.

6. A method according to claim 1, which includes the additional steps of:
a) arranging a second hologram mask of a second pattern, having a surface area substantially smaller than that of the substrate, on a first face of a second coupling element;
b) arranging the second coupling element and second hologram mask in relation to the first coupling element and first hologram mask such that the second hologram mask is substantially coplanar with the first hologram mask;
c) arranging the substrate in relation to the second hologram mask such that it is substantially parallel and in proximity to the second hologram mask and such that it is laterally positioned with respect to at least a first part of the second pattern recorded in the second hologram mask;
d) printing in focus at least the first part of the second pattern recorded in the second hologram mask into the photosensitive layer on the substrate by scanning a second exposure beam through a second face of said second coupling element and reconstructing at least the first part of the pattern recorded in the second hologram mask while simultaneously measuring the local separation of the substrate and second hologram mask where reconstruction is taking place by scanning a second focus beam through the second or a third face of said second coupling element and continuously correcting said separation by displacing the second hologram mask and second coupling element;
e) displacing the substrate in relation to the second hologram mask such that it remains substantially parallel and in proximity to the second hologram mask and such that an unexposed part of the photosensitive layer on the substrate is laterally positioned with respect to at least the first or a second part of the second pattern recorded in the second hologram mask;
f) printing in focus at least the first or second part of the second pattern recorded in the second hologram mask into the photosensitive layer on the substrate by scanning a second exposure beam through a second face of said second coupling element and reconstructing at least the first or second part of the pattern recorded in the second hologram mask while simultaneously measuring the local separation of the substrate and second hologram mask where reconstruction is taking place by scanning a second focus beam through the second or a third face of said second coupling element and continuously correcting said separation by displacing the second hologram mask and second coupling element.

7. A method according to claim 6 wherein at least one of steps relating to the second hologram mask is performed substantially concurrently with at least one of the steps relating to the first hologram mask.

8. A method according to claim 6 wherein the lateral positioning, in steps c) and e), of the substrate with respect to at least a part of the second pattern recorded in the second hologram mask is wholly or substantially obtained by displacing the substrate and otherwise by displacing the second hologram mask and second coupling element.

9. A method according to claim 6, which includes before at least one of the printing steps the additional steps of firstly measuring at least one of the position of the first pattern or part thereof recorded in the first hologram mask relative to that of the second pattern or part thereof recorded in the second hologram mask, and secondly displacing the first coupling element with first hologram mask relative to the second coupling element with second hologram mask such that the patterns or parts printed from said first and second hologram masks are accurately mutually aligned, or stitched together.

10. A method according to claim 6, which includes before at least one of the printing steps the further steps of firstly measuring at least one of the lateral position of the first pattern or part thereof recorded in the first hologram mask relative to a lower-level pattern or part thereof previously printed below the photosensitive layer on the substrate and the lateral position of the second pattern or part thereof recorded in the second hologram mask relative to a lower-level pattern or part thereof previously printed below the photosensitive layer on the substrate, and secondly laterally displacing at least one of the first coupling element with first hologram mask relative to the substrate and the second coupling element with second hologram mask relative to the substrate such that the pattern or patterns printed therefrom are accurately aligned with respect to the pattern or parts thereof previously printed below the photosensitive layer on the substrate, wherein the lateral displacements of the first and second hologram masks relative to the substrate are obtained by lateral displacements of at least one of the first and second hologram masks and the substrate.

11. An apparatus for printing a composite pattern into a photosensitive layer on a substrate, which apparatus includes:
a) a first hologram mask of a first pattern, having a surface area substantially smaller that of the substrate, on a first face of a first coupling element;
b) a substrate positioning means arranged with respect to the first hologram mask on the first coupling element for positioning a substrate arranged thereon substantially parallel to and in proximity to the first hologram mask and for laterally displacing the substrate in at least one of two orthogonal directions relative to the first hologram mask;
c) a first exposure means for reconstructing at least a part of the first pattern recorded in the first hologram mask by scanning a first exposure beam through a second face of the first coupling element;
d) a first focus means for measuring the local separation of the substrate and first hologram mask where at least the part of the first pattern is being reconstructed by said first exposure beam, by scanning a first focus beam through the second or a third face of the first coupling element;
e) a first hologram mask positioning means including means for longitudinally displacing the first coupling element and hologram mask in relation to the substrate in response to said measurements by the first focus means such that the first pattern or part thereof reconstructed from said first hologram mask by said first exposure means is printed in focus into the photosensitive layer on the substrate.

12. An apparatus according to claim 11, which further includes an interferometer system for accurately measuring the displacement of the substrate produced by the substrate positioning means.

13. An apparatus according to claim 11, which further includes an alignment measurement means for measuring the lateral position of the first pattern or part thereof recorded in the first hologram mask relative to a pattern or part thereof previously printed below the photosensitive layer on the substrate.

14. An apparatus according to claim 11, which further includes:
a) a second hologram mask of a second pattern, having a surface area substantially smaller than that of the substrate, on a first face of a second coupling element which is arranged in relation to the first coupling element such that the first and second hologram masks are substantially coplanar;
b) a second exposure means for reconstructing at least a part of the second pattern recorded in the second hologram mask by scanning a second exposure beam through a second face of the second coupling element;
c) a second focus means for measuring the local separation of the substrate and second hologram mask where at least a part of the second pattern is being reconstructed by said second exposure beam, by scanning a second focus beam through the second or a third face of the second coupling element;
d) a second hologram mask positioning means including means for longitudinally displacing the second coupling element and second hologram mask in relation to the substrate in response to said measurements by the second focus means such that at least a part of the second pattern reconstructed from the second hologram mask by said second exposure means is printed in focus into the photosensitive layer on the substrate.

15. An apparatus according to claim 14, wherein at least one of the first and second hologram mask positioning means includes means for laterally displacing the respective hologram mask or masks relative to a substrate on the substrate positioning means.

16. An apparatus according to claim 15, wherein the lateral displacement means for the respective hologram mask or masks includes means for rotating the hologram mask about an axis orthogonal to the plane of the hologram mask.

17. An apparatus according to claim 14, which further includes means for measuring at least one of the position and orientation of the first pattern or part thereof recorded in the first hologram mask with respect to the position and orientation of the second pattern or part thereof recorded in the second hologram mask.

18. An apparatus according to claim 14, which further includes a first alignment measurement means for measuring the position of the first pattern or part thereof recorded in the first hologram mask relative to a lower-level pattern or part thereof previously printed below the photosensitive layer on the substrate and a second alignment means for measuring the position of the second pattern or part thereof recorded in the second hologram mask relative to a lower-level pattern or part thereof previously printed below the photosensitive layer on the substrate.

19. An apparatus according to claim 14 that further includes means, such as an interferometer system, for directly measuring lateral displacements, parallel to the plane of the substrate, of at least one the first and second hologram masks produced by the respective first and second hologram mask positioning means.

20. An apparatus according to claim 14, which further includes at least one other coupling prism with another hologram mask arranged thereon as well as additional hologram mask positioning means, exposure means and focus means for printing in focus the pattern or patterns recorded therein into the photosensitive layer on the substrate.
